(19) United States
(12) Patent Application Publication
(10) Pub. No.: US 2017/0313136 A1
(43) Pub. Date: Nov. 2, 2017

(54) Pneumatic Vehicle Tyre

(71) Applicant: CONTINENTAL REIFEN DEUTSCHLAND GMBH, Hannover (DE)

(72) Inventors: Björn-Birk Gläser, Monroe, SC (US); Charles Henry Boston, Hannover (DE); Andreas Domscheit, Hannover (DE); Oliver Schürmann, Langenhagen (DE); Ulrich Behr, Hannover (DE)

(73) Assignee: CONTINENTAL REIFEN DEUTSCHLAND GMBH, Hannover (DE)

(21) Appl. No.: 15/526,596

(22) PCT Filed: Aug. 3, 2015
(86) PCT No.: PCT/EP2015/067793

§ 371 Date: May 12, 2017

(30) Foreign Application Priority Data
Nov. 19, 2014 (DE) 10 2014 223 599.5

(51) Int. Cl. B60C 11/04; B60C 11/13; B60C 11/03

(52) U.S. Cl. CPC B60C 11/045; B60C 11/1323; B60C 11/0304; B60C 11/0309; B60C 11/1315

(57) ABSTRACT

A pneumatic vehicle type for passenger vehicles or vans having at least one wide circumferential groove (1, 1′, 1″, 1″′), which runs in the circumferential direction and is bounded on the tread periphery by two edge borders (1a, 1′a, 1″a, 1′″a) which run parallel to one another and linearly, and has a groove base (13, 13′, 13″) as well as two groove edges (9, 10, 9′, 10′, 9″, 10″), wherein elements (11, 12, 11′12′, 11″, 12″) which project on the groove edges (9, 10, 9′, 10′, 9″, 10″) are formed alternately in the circumferential direction on one or other of the groove edges (9, 10, 9′, 10′, 9″, 10″), wherein each projecting element (11, 12, 11′, 12′, 11″, 12″) has a groove edge section (9a, 10a, 9′a, 10′a, 9″a, 10″a) lying opposite on the opposite groove edge (9, 10, 9′, 10′, 9″, 10″), which groove edge section (9a, 10a, 9′a, 10′a, 9″a, 10″a) runs least essentially in the radial direction starting at the edge border (1a, 1′a, 1″a, 1′″a) as far as the groove base (13, 13′, 13″), wherein the groove base (13, 13′, 13″) runs in a meandering or corrugated shape along and between the projecting elements (11, 12, 11′, 12′, 11″, 12″), wherein the projecting elements (11, 12, 11′, 12′, 11″, 12″) are essentially of wedge-like design and are bounded by oblique faces (14, 14′, 14″) which extend in the axial direction as far as the groove base (13, 13′, 13″) and run in the circumferential direction at least essentially over the circumferential extent of the elements (11, 12, 11′, 12′, 11″, 12″), wherein the projecting elements (11, 12; 11′,12′,11″,12″) are provided in at least two different circumferential lengths (L₁ to L₅, L₁′ to L₅′; L₁″ to L₅″) and follow one another according to a specific sequence over the circumference of the circumferential groove (1, 1′, 1″, 1″′).

### DESCRIPTION

The invention relates to a pneumatic vehicle tire for passenger cars or vans with at least one wide circumferential groove, which runs in the circumferential direction and is bounded at the tread periphery by two bordering edges, which run parallel to one another and linearly, and has a groove base and also two groove flanks, wherein elements projecting on the groove flanks are formed alternately in the circumferential direction on one or the other groove flank, wherein there is lying opposite each projecting element on the opposite groove flank a groove flank portion which runs at least substantially in the radial direction, beginning at the bordering edge, up to the groove base, wherein the groove base runs in a meandering or wavy manner along and between the projecting elements.

Such a pneumatic vehicle tire, which is preferably a commercial vehicle tire, is known from EP 2 144 767 B 1. The elements arranged on the groove flanks and projecting from them are parts or portions of pointed bodies, the base surfaces of which are assigned to the groove base and the apexes of which lie adjacent to the tread periphery. The projecting elements are portions of cones or cone-like bodies. Projecting elements designed in such a way provide surfaces that have a large opening angle and many faces, which are intended to prevent foreign bodies, such as stones, from penetrating or to help to eject foreign bodies.

In the case of pneumatic vehicle tires for passenger cars or vans it has until now been unusual to form projecting elements on the groove flanks of circumferential grooves. The grooves that are mostly provided in such tires, running around linearly in the circumferential direction, have the primary purpose of ensuring good water expulsion. It is therefore ensured that the circumferential grooves allow water to flow through as unhindered as possible. However, circumferential grooves designed in such a way produce noises during the rolling of the tire; for example, when the tire is running on the underlying surface they form a kind of tube with an open inlet and outlet. The rotation of the tire may produce in the tube a standing wave, which is intensified by what is known as the “horn” effect and propagates in the air. This causes noises that are unpleasant for the human ear in the particularly sensitive 1000 Hz range. The larger the cross section of the circumferential grooves, the better the properties of the pneumatic vehicle tire on a wet underlying surface; the smaller the cross section of the grooves, however, the less sound waves occur and propagate in the circumferential grooves. Circumferential grooves in the tread also cause a non-uniform distribution of stiffness and distribution of material in the tread over the cross section of the tread. This may lead to the formation of a certain waviness in the breaker belt and in the carcass. The effects mentioned may adversely influence the rolling resistance and lead to the excitation of vibrations in the breaker belt and carcass during rolling, which in turn increases the acoustic emissions from the tire, the audible noise.

It is already known from EP 2 406 088 B1 for reducing the aforementioned noise effects to form elevations at certain intervals on the groove base of the circumferential grooves in the direction of the extent of the circumferential grooves; in particular, these elevations are provided in the circumferential grooves in pairs and at relatively great intervals. The noise-reducing effect of this known design is not satisfactory.

The invention is therefore based on the object of designing the elements projecting on the groove flanks of a tire of the type mentioned at the beginning in such a way that principally the occurrence and propagation of sound waves, in particular the formation of the aforementioned effects, is reduced or prevented, while however it is intended at the same time for good expulsion of water to be ensured.

The set object is achieved according to the invention by the projecting elements being of a substantially wedge-like design and being bounded by oblique faces, which extend in the axial direction up to the groove base and run in the circumferential direction at least substantially over the circumferential extent of the elements, wherein the projecting elements are provided in at least two different circumferential lengths and follow one another according to a specific sequence over the circumference of the circumferential groove.

By designing the projecting elements as bodies that are formed in a substantially wedge-like manner, which are arranged in the circumferential direction alternately on the one and the other groove flank, these elements form obstacles that hinder or prevent the occurrence and propagation of sound waves. The different circumferential lengths additionally counteract the occurrence of resonances, and therefore likewise contribute to reducing audible sound waves. The oblique faces dominate the projecting elements, so that they reduce the cross section of the grooves only a little. Good performance in the wet and a good water draining capability of the circumferential grooves is therefore retained. Advantageously, circumferential grooves of such a design also have the effect of increasing the uniformity of the stiffness of the profile structures or of the distribution of material over the cross section of the tire. This measure is also of advantage for the noise emission, and also for the tire uniformity and abrasion.

It is in this case advantageous for a good water draining capability of the circumferential grooves if, according to the invention, the oblique faces run at an angle of 30° to 60° to the radial direction.

In the case of a preferred embodiment, projecting elements of which the oblique faces run linearly in cross section are provided, so that the oblique faces are planar faces. In the case of planar oblique faces, it is advantageous to choose their angle of inclination to the radial direction as rather larger. In the case of a further, alternative embodiment of the invention, projecting elements of which the oblique faces are convexly or concavely curved in cross section are provided. Also in the case of this embodiment, it is advantageous to choose the inclination of the oblique faces in relation to the radial direction in such a way that the cross-sectional area of the grooves remains as large as possible.

Further measures according to the invention contribute to hindering or even preventing the occurrence and propagation of sound waves in the circumferential grooves. It is of advantage in this connection if the groove base is made up of groove base portions running in the circumferential direction, offset with respect to one another in the radial direction alternately in the circumferential direction, connecting portions and rounded corner portions running between them, wherein the connecting portions may run either at least substantially in the axial direction or at an angle with respect to the axial direction. In this case, all of the connecting portions may run inclined either in the same sense or alternating in opposite senses in relation to the axial direction. The rounded corner portions may run over angular regions of 30° to 150° , in particular 45° to 135°.

In the case of a preferred embodiment of the invention, oblique faces that begin at the bordering edges are provided. In the case of further variants of the invention, oblique faces that begin at a radial distance of in particular 0.5 mm to 3 mm from the bordering edges are provided, so that, depending on the chosen inclination of the oblique faces, the cross-sectional area of the grooves can be influenced correspondingly.

In order to keep the occurrence of resonant effects in the circumferential grooves as low as possible, it is also of advantage if the projecting elements are provided in up to five different circumferential lengths, wherein the greatest circumferential length is preferably longer by up to 65% than the smallest circumferential length.

In the case of a preferred configuration of the tread profile, the smallest circumferential length is 6 mm to 16 mm; in the case of another design according to the invention, the smallest circumferential length is 18 mm to 30 mm.

In the case of a further preferred embodiment of the invention, which likewise has a favorable effect on the sound emissions during the rolling of the tire, the number and size of the different circumferential lengths of the projecting elements and their sequence correspond to those of the pitch sequence of the profile positives in the tread.

Further features, advantages and details of the invention are now described in more detail on the basis of the drawing, which schematically shows exemplary embodiments of the invention. In the drawing:

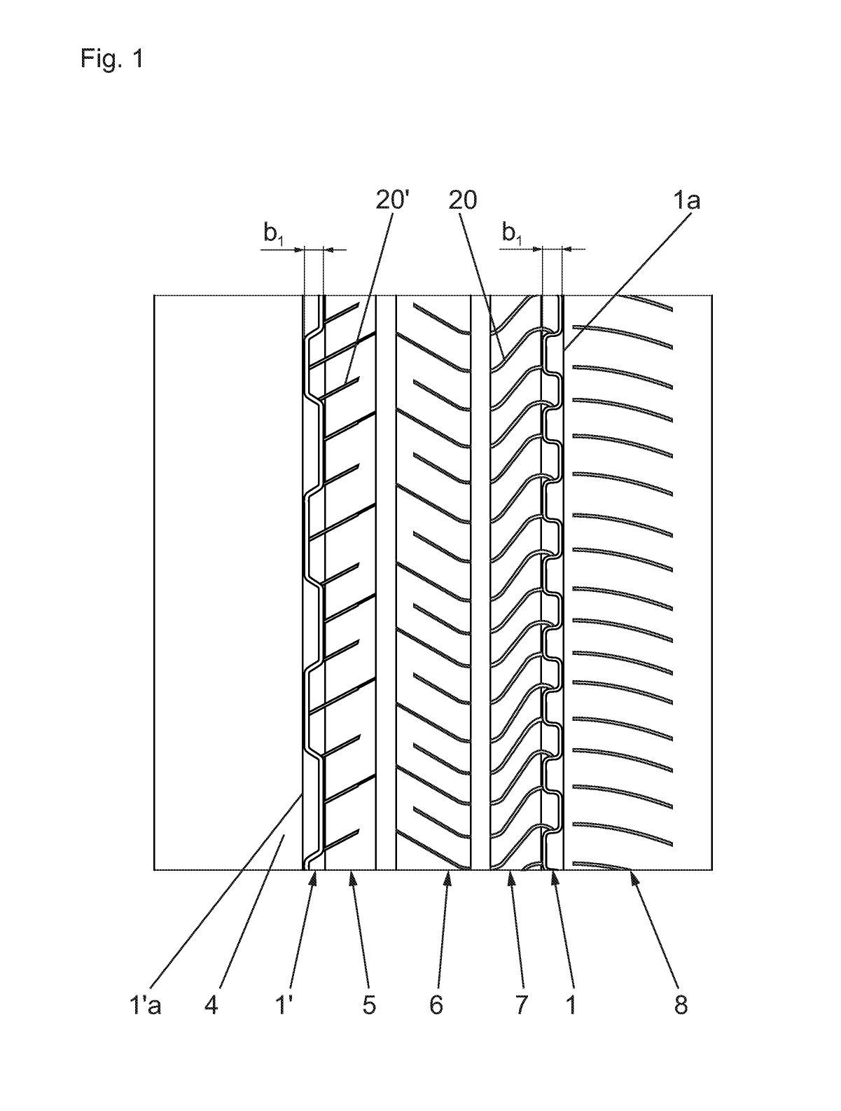

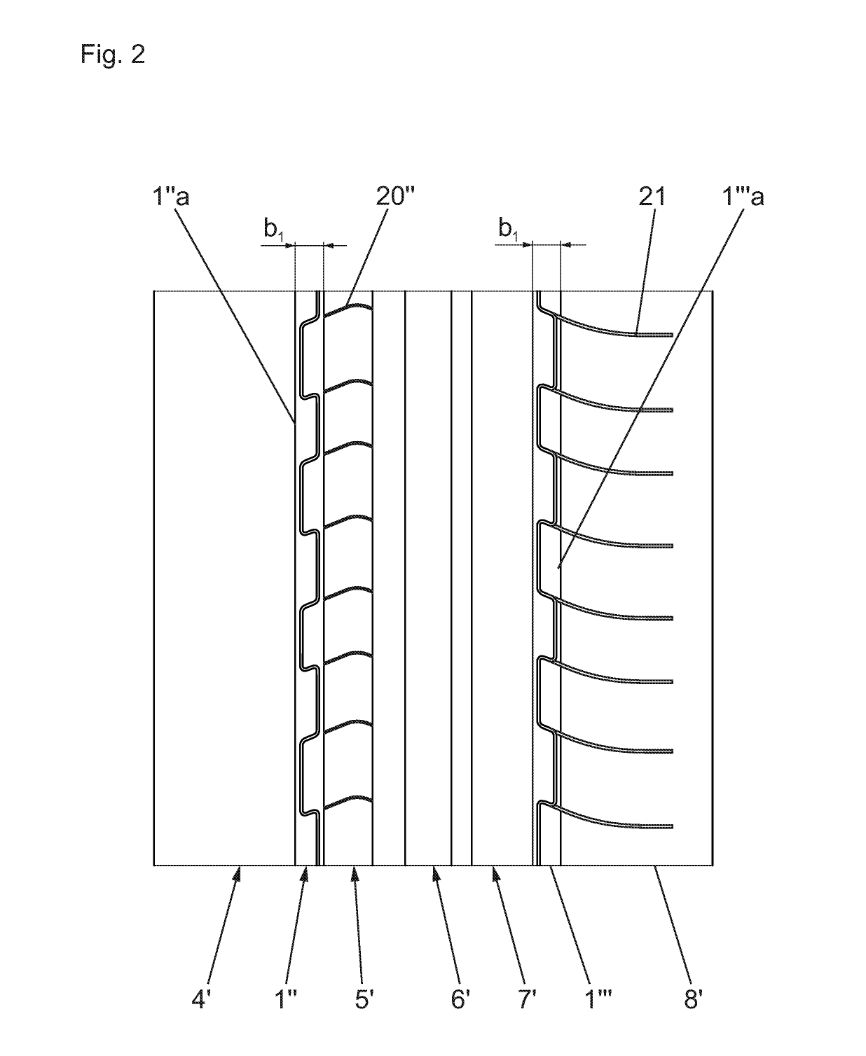

FIG. 1 and FIG. 2 respectively show a plan view of a circumferential portion of a tread of a pneumatic vehicle tire with different design variants of the invention,

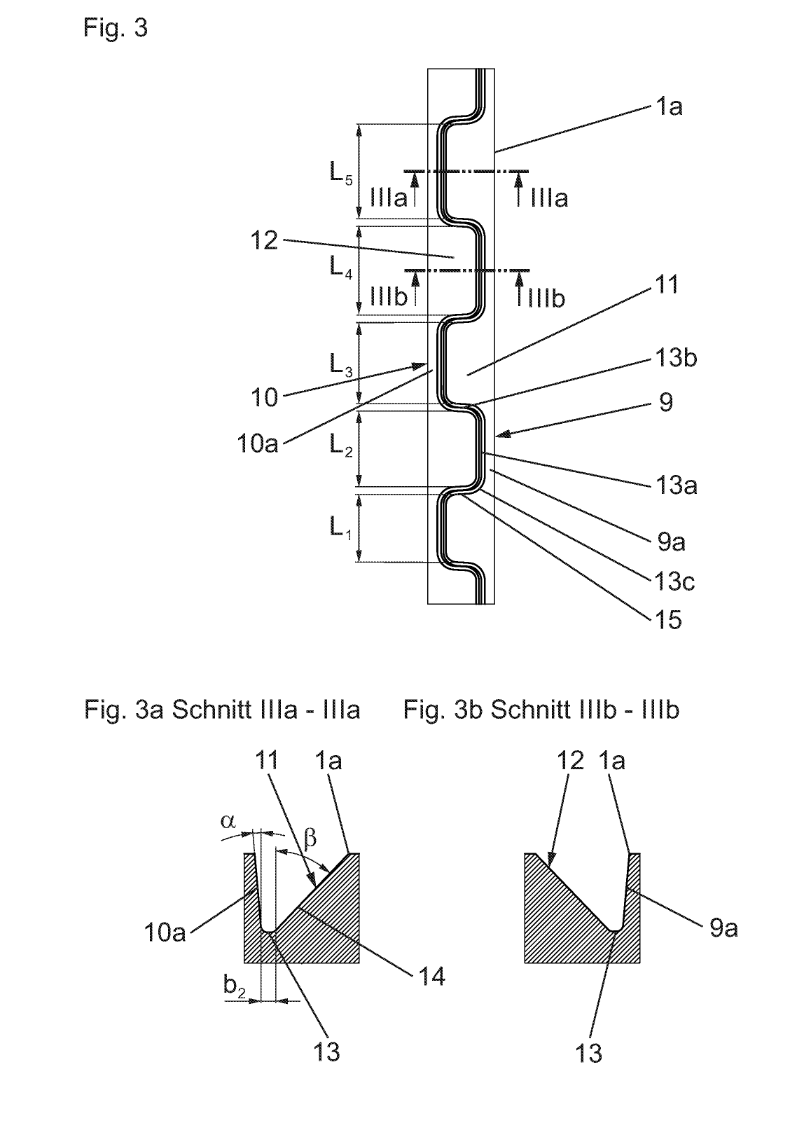

FIG. 3 shows a detail of FIG. 1 in an enlarged representation,

FIG. 3a shows a section along the line IIIa-IIIc of FIG. 3,

FIG. 3b shows a section along the line IIIb-IIIb of FIG. 3,

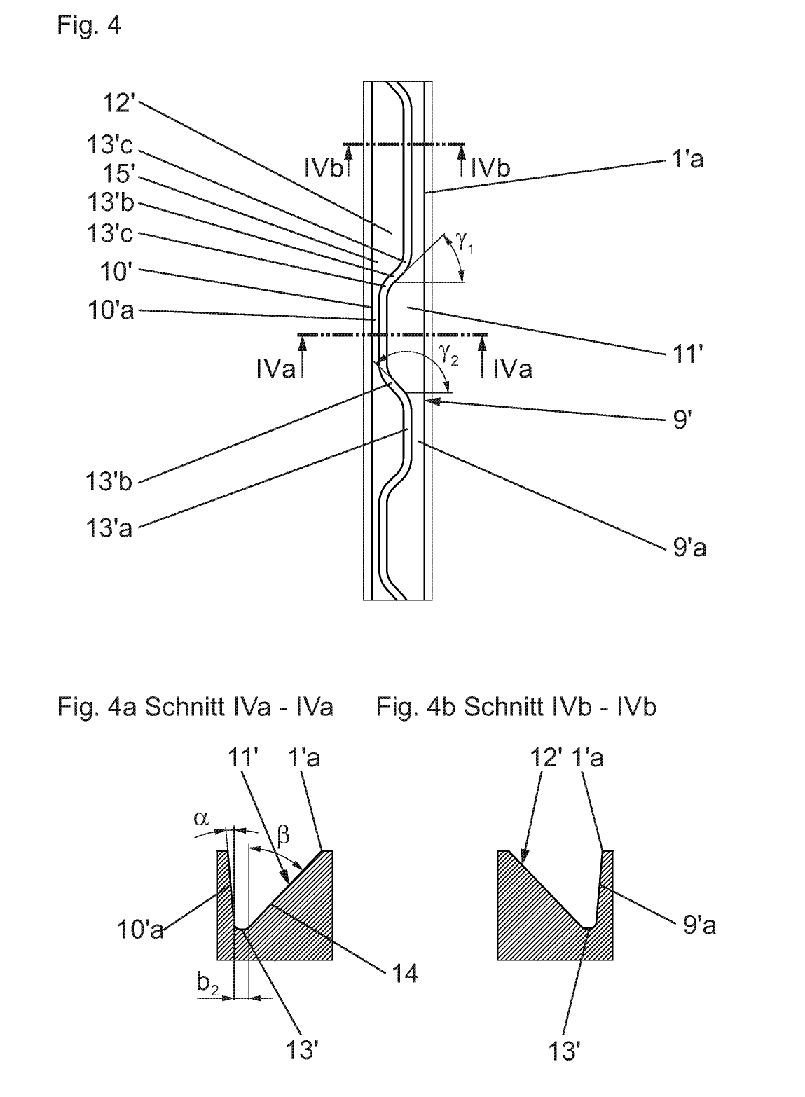

FIG. 4 shows a further detail of FIG. 1 in an enlarged representation,

FIG. 4a shows a section along the line IVa-IVa of FIG. 4,

FIG. 4b shows a section along the line IVb-IVb of FIG. 4,

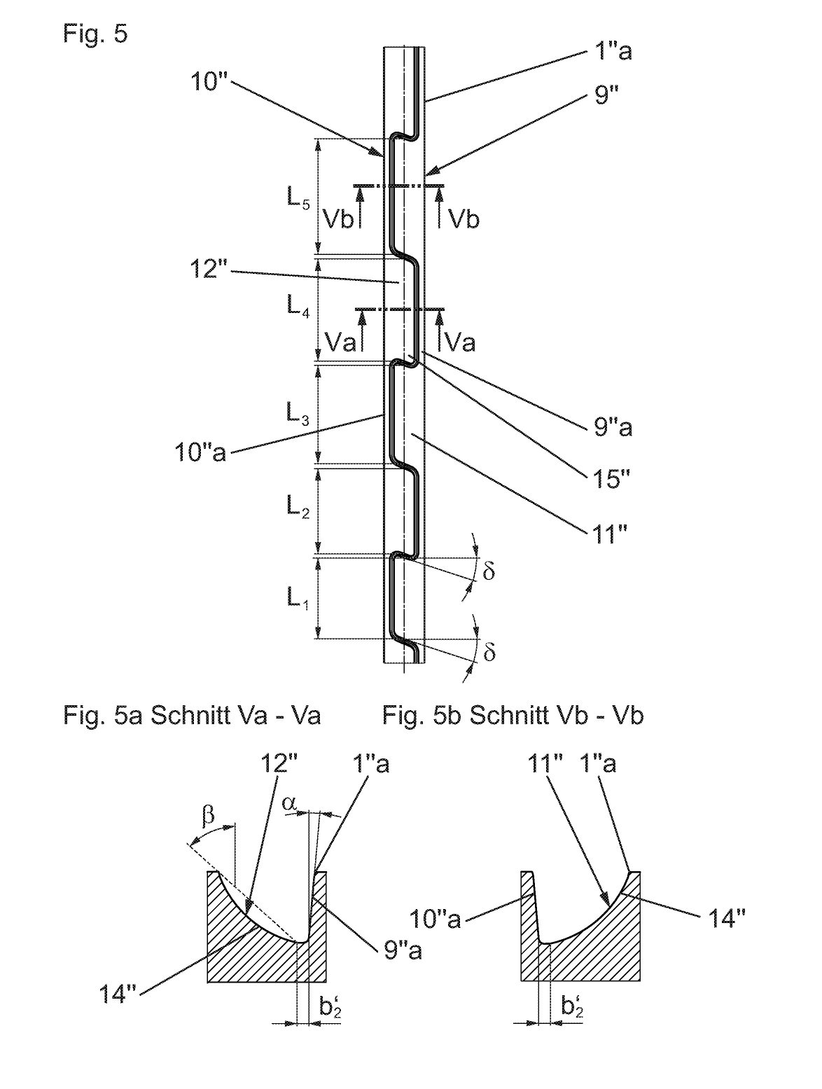

FIG. 5 shows a detail of FIG. 2 in an enlarged representation,

FIG. 5a shows a section along the line Va-Va of FIG. 5,

FIG. 5b shows a section along the line Vb-Vb of FIG. 5 and

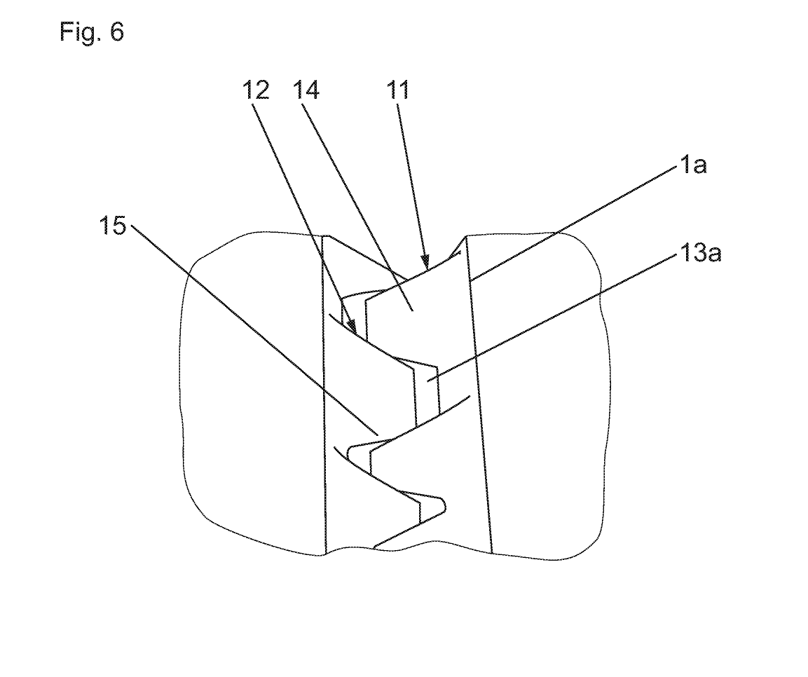

FIG. 6 shows a perspective view of a detail of FIG. 1.

The invention is concerned with the specific configuration of circumferential grooves in the tread of a pneumatic vehicle tire for passenger cars or vans for reducing the tire/roadway noise, in particular that component that occurs during the rolling of the tire due to or in the circumferential grooves. The occurrence and propagation of sound waves in circumferential grooves is attributable in particular to what is known as the “horn” effect, which here is an intensification of the emitted sound as a result of the formation of an acoustic horn between the curved running surface of the tire and the roadway at the run-in and run-out of the tire. In addition, during the rolling process, circumferential grooves form tubular resonators with the roadway surface, while flow processes and periodic interactions of these resonators may cause noise components to occur in the tire/roadway noise.

FIGS. 1 and 2 respectively show by way of example and schematically a plan view of a circumferential portion of a tread with four wide circumferential grooves 1, 1′, 2, 3 (FIG. 1) and 1″, 1″′, 2′, 3′ (FIG. 2), which separate from one another or bound profile strips 4, 5, 6, 7, 8 and 4′, 5′, 6′, 7′, 8′, respectively, which are shown largely unstructured. The circumferential grooves 1, 1′, 1″, 1′″ running at the shoulders, which in the case of the embodiment shown are designed according to the invention, are discussed in more detail below. Considering the tire in the new state, the circumferential grooves 1, 1′, 1″, 1″′ respectively have two bordering edges 1a, 1′a, 1″a and 1″′ a running linearly and parallel to one another at the tread periphery. Also shown are transverse grooves 20, 20′ (FIG. 1) and transverse grooves 20″ (FIG. 2) and also sipes 21 (FIG. 2), to which reference will be made further below. Further sipes and grooves that are not represented may be provided, in which case the profile strips may also be divided into profile blocks. The maximum depth of the circumferential grooves 1, 1′, 1″, 1″′ corresponds to the intended profile depth, which in the case of car tires is usually between 6.0 mm and 8.5 mm; their width b₁ at the tread periphery, which corresponds to the mutual spacing of the respective bordering edges 1a, 1′a, 1″a, 1′″a, is preferably 8 mm to 10 mm.

In the case of the embodiments shown in FIG. 1, the two circumferential grooves 1, 1′ running at the shoulders are provided according to the invention with specially structured groove flanks 9, 10 and 9′, 10′, respectively, as well as with a specially running groove base 13, 13′. As shown, it is possible to provide circumferential grooves 1, 1′ on one and the same tread, but it is also possible for example to provide two circumferential grooves of the same embodiment on a tread. As shown in FIGS. 1 and 2, it is also particularly advantageous for reducing the tire/roadway noise if in particular the circumferential grooves 1, 1′, 1″, 1′″ running at the shoulders are designed according to the invention. The circumferential grooves 2, 3, 2′, 3′ running in the middle region of the tread may be provided in the conventional way with a wide groove base and with groove flanks running linearly in the radial direction and in cross section.

As FIGS. 3, 3a, 3b and also FIG. 6 in particular show, projecting elements 11, 12 are arranged on the mutually opposite groove flanks 9, 10 of the circumferential groove 1 in such a way that, considered in the circumferential direction, a projecting element 11 provided on the one groove flank 9 respectively alternates with a projecting element 12 provided on the other groove flank 10. Lying opposite an element 11 on the groove flank 9 there is a groove flank portion 10a on the other groove flank 10, lying opposite an element 12 on the groove flank 10 there is a groove flank portion 9a on the other groove flank 9. The groove flank portions 9a, 10a run substantially linearly in the radial direction and in cross section; in the case of the embodiment shown, the groove flank portions 9a, 10a form a small acute angle a of up to 10° with the radial direction. The groove flank portions 9a, 10a have a circumferential extent that correlates with the circumferential extent of the elements 11, 12. The groove flank portions 9a, 10a directly adjoin the groove base 13, which in cross section is designed as substantially rounded and, including the roundings, has a width b2 of up to approximately 1.5 mm. The groove base 13 is accordingly made up in plan view of groove base portions 13a, which run linearly along the groove flank portions 9a, 10a, are oriented in the circumferential direction and are offset with respect to one another alternately in the axial direction, and of connecting portions 13b, which connect the groove base portions 13a running in the circumferential direction to one another by way of rounded 90° corner portions 13c. The connecting portions 13b run substantially in the axial direction and go over into the groove base portions 13a via the 90° corner portions 13c.

In the case of the embodiment shown, the projecting elements 11, 12 are bodies formed in a substantially wedge-like manner, in each case with an oblique face 14 running from the respective bordering edge la directly up to the groove base 13, and substantially triangular side faces 15, wherein the transitions between the oblique faces 14 and the associated side faces 15 are rounded in a way corresponding to the shape of the groove base 13. In plan view, the oblique faces 14 are surfaces that are planar and substantially rectangular, which have a circumferential extent that substantially corresponds to the circumferential extent of the groove flank portions 9a, 10a and the groove base portions 13a. The oblique faces 14 form with the radial direction an angle β, which is chosen between 30° and 60° and is in particular of the order of magnitude of 45° .

According to a preferred embodiment of the invention, the circumferential extent of the projecting elements 11, 12 varies, and accordingly so too does the circumferential extent of the groove base portions 13a running at the foot of the elements 11, 12, in particular in such a way that they are provided with at least two different circumferential lengths. In the case of the embodiment shown, the elements 11, 12 have five different, progressively greater circumferential lengths L₁ to L₅, which, by analogy with the known methods of pitch length variation of profile positives in the tread, follow one another in a specific sequence in the circumferential direction. The length variation takes place in particular in such a way that the greatest circumferential length Ls is greater by up to 65% than the smallest circumferential length L₁. In the case of the embodiment shown, the smallest circumferential length L₁ is for example of the order of magnitude of 6 mm to 16 mm.

As a departure from the embodiment shown, the oblique faces 14 may also all be slightly convexly or slightly concavely curved in cross section. A design in which the one elements 11 have convexly curved oblique faces and the other elements 12 have concavely curved oblique faces is also possible, or combinations of cross-sectionally linear oblique faces with convexly or concavely curved oblique faces are also possible. In the case of convexly or concavely curved oblique faces, their angle of inclination β is the angle of a straight line connecting the bordering edge to the end of the oblique face at the groove base in relation to the radial direction.

In the case of the second design variant of the invention, concerning the circumferential groove 1′ and shown in particular in FIGS. 4, 4a and 4b, projecting elements 11′ and 12′, which are formed on the two groove flanks 9′, 10′, likewise alternate with one another in the circumferential direction in a way analogous to the circumferential groove 1. Lying opposite the elements 11′, 12′ there is in each case a groove flank portion 9′a, 10′a and in between in each case a groove base portion 13′a. The elements 11′, 12′ are likewise substantially wedge-shaped, with oblique faces 14′ which, in the embodiment shown, run linearly in cross section and are therefore of a planar design. Also in the case of this embodiment, the groove base 13′, which has a width b₂′ of approximately 1.5 mm, has connecting portions 13′b, running between the groove base portions 13′a, and rounded corner portions 13′c. In plan view, the connecting portions 13′b run respectively in relation to the axial direction at an angle γ₁, γ₂ with an inclination alternating in opposite senses, wherein the angle γ₁ is of the order of 30° to 90° , in particular up to 60° , and γ₂ is 120° to 180° , in particular 150° . The corner portions 13′c therefore “run around” in each case the angle that is complementary to the angle γ₁, γ₂. The shape and arrangement of the side faces 15′ of the elements 11′, 12′ correlate with the shape of the connecting portions 13′b. Also in the case of this embodiment, the projecting elements 11′, 12′ have circumferential lengths of different sizes, here by way of example likewise formed in five different, progressively greater circumferential lengths L₁′ to L₅′, wherein the greatest circumferential length L₅′ is greater by up to 65% than the smallest circumferential length L₁′. In the case of the exemplary embodiment shown, the smallest circumferential length L₁′ is of the order of magnitude of 18 mm to 30 mm.

In the case of this embodiment, the elements 11′, 12′ may be provided with oblique faces 14′, which have a slightly convex or concave curvature in cross section.

FIGS. 5, 5a and 5b illustrate the embodiment of the invention that is shown in the circumferential grooves 1″ and 1″′ of FIG. 2. By analogy with the embodiments already described, also in the case of this embodiment projecting elements 11″ and 12″, which are formed on the groove flanks 9″and 10″, alternate with one another in the circumferential direction. Groove flank portions 9″a and 10″a are located opposite the elements 11″ and 12″; between the elements 11″, 12″ the groove flank portions 9″a and 10″a there runs in each case a groove base portion 13″a. The elements 11″, 12″, which are likewise of a wedge-shaped design here, have in cross section slightly concavely curved oblique faces 14″, wherein the radius of curvature is of the order of magnitude of 10 mm. By analogy with the embodiments already described, the groove base 13″ has a width b₂″ of approximately 1.5 mm; between the groove base portions 13″a offset with respect to one another in the axial direction there run connecting portions 13″b and rounded corner portions 13″c. Considered in plan view, the connecting portions 13″b run at least substantially parallel to one another, but in relation to the axial direction at angles δ of the order of magnitude of up to 45° , in particular of 10° to 45° , wherein, as a result of the inclination in the same sense of the connecting portions 13″b in relation to the axial direction, the corner portions 13″c run in the circumferential direction alternately along an acute angle and an obtuse angle. As already in the case of the previous exemplary embodiments, also in the case of this exemplary embodiment it is provided that the projecting elements 11″, 12″ are formed in circumferential lengths of different sizes, here too by way of example in five different, progressively greater circumferential lengths L₁″ to L₅″; the greatest circumferential length L₅″ is up to 65% greater than the smallest circumferential length L₁″. The smallest circumferential length L₁″ may be for example of the order of magnitude of 20 mm to 24 mm.

In the case of the embodiments of the invention shown, oblique faces 14, 14′, 14″ are provided, which begin at the bordering edges 1a, 1′a, 1″a, 1″′a. In the case of further variants of the invention that are not shown, oblique faces 14, 14′, 14″ that begin at a radial distance of in particular 0.5 mm to 3 mm from the bordering edges 1a, 1′a, 1″a, 1″′a may be provided. In this case, narrow groove flank portions are present between the projecting elements and the bordering edges.

In the case of all of the design variants, the elements 11, 12, 11′, 12′ formed with different circumferential lengths may be designed in such a way that the number and sequence of their circumferential lengths is coupled to the pitch sequence of the tread profiling, as shown in FIG. 1 and FIG. 2, where the transverse grooves 20, 20′, 20″ and also the sipes 21 are arranged according to the pitch sequences of the tread profilings. The arrangement may however also be such that the projections 11, 12 or 11′, 12′ are respectively arranged in the circumferential grooves according to a sequence of their own over the circumference of the tire. Features of the individual design variants may also be combined with one another in any way desired.

### LIST OF REFERENCE DESIGNATIONS

1, 1′, 2, 3 . . . circumferential groove
1″, 1′″, 3′ . . . circumferential groove
1a, 1′a, 1″a, 1′″a . . . bordering edge
4, 5, 6, 7, 8 . . . profile strip
4′, 5′, 6′, 7′, 8′ . . . profile strip
9, 9′ . . . groove flank
10, 10′ . . . groove flank
9a, 9′a, 9″a . . . groove flank portion
10a, 10′a, 10″a . . . groove flank portion
11, 11′, 11″ . . . projecting element
12, 12′, 12″ . . . projecting element
13, 13′, 13″ . . . groove base
13a, 13′a, 13″a . . . groove base portion
13b, 13′b, 13″b . . . connecting portion
13c, 13′c, 13″c . . . corner portion
14, 14′, 14″ . . . oblique face
15, 15′, 15″ . . . side face
b₁ . . . width
b₂, b₂′, b₂″ . . . width
L₁ to L₅ . . . circumferential length
L₁′ to L₅′ . . . circumferential length
L₁″ to L₅″ . . . circumferential length
α, β, γ₁, γ₂, δ . . . angle

1-15. (canceled)

16. A pneumatic vehicle tire comprising at least one wide circumferential groove running in a circumferential direction of the pneumatic vehicle tire and is bounded at a tread periphery by two bordering edges which run parallel to one another and linearly, wherein the at least one wide circumferential groove running comprises a groove base and two groove flanks, wherein elements are formed alternately in the circumferential direction and project on a first of the two groove flanks, wherein there is lying, opposite each of the elements, on a second of the groove flanks, a groove flank portion which runs at least substantially in a radial direction of the pneumatic vehicle tire and, beginning at a bordering edge, runs up to the groove base, and wherein the groove base runs in a meandering or wavy manner along and between the projecting elements; and,
wherein the elements are of a substantially wedge-like design and bounded by oblique faces which extend in the axial direction up to the groove base and run in the circumferential direction at least substantially over a circumferential extent of the elements, and wherein the elements are provided in at least two different circumferential lengths and follow one another according to a specific sequence over a circumference of the circumferential groove.

17. The pneumatic vehicle tire as claimed in claim 16, wherein the oblique faces run at an angle (β) of 30° to 60° relative to the radial direction.

18. The pneumatic vehicle tire as claimed in claim 16, wherein the elements comprise oblique faces which are planar faces.

19. The pneumatic vehicle tire as claimed in claim 16, wherein the elements comprise oblique faces which are convexly or concavely curved.

20. The pneumatic vehicle tire as claimed in claim 16, wherein the oblique faces begin at a bordering edge.

21. The pneumatic vehicle tire as claimed in claim 16, wherein the oblique faces begin at a radial distance of from 0.5 mm to 3 mm from the bordering edge.

22. The pneumatic vehicle tire as claimed in claim 16, wherein the groove base comprises groove base portions running in the circumferential direction, which are offset with respect to one another in the axial direction alternately in the circumferential direction, and wherein connecting portions and rounded corner portions are running between groove base portions.

23. The pneumatic vehicle tire as claimed in claim 22, wherein the connecting portions run at least substantially in the axial direction.

24. The pneumatic vehicle tire as claimed in claim 22, wherein the connecting portions run with respect to the axial direction at an angle (γ₁, γ₂, δ), and wherein all of the connecting portions are inclined either in the same sense or alternating in opposite senses in relation to the axial direction.

25. The pneumatic vehicle tire as claimed in claim 22, wherein the rounded corner portions run over 30° to 150° .

26. The pneumatic vehicle tire as claimed in claim 25, wherein the rounded corner portions run over 45° to 135° .

27. The pneumatic vehicle tire as claimed in claim 16, wherein the elements are provided in up to five different circumferential lengths.

28. The pneumatic vehicle tire as claimed in claim 27, wherein a greatest of the up to five different circumferential lengths is longer by up to 65% than a smallest of the up to five different circumferential lengths.

29. The pneumatic vehicle tire as claimed in claim 27, wherein a smallest of the up to five different circumferential lengths is from 6 mm to 16 mm.

30. The pneumatic vehicle tire as claimed in claim 27, wherein a smallest of the up to five different circumferential lengths is 18 mm to 30 mm.

31. The pneumatic vehicle tire as claimed in claim 27, wherein the number and size of the up to five different circumferential lengths of the elements and their sequence corresponds or correspond to those or that of a pitch sequence of profile positives in the tread.
